(19) United States
(12) Patent Application Publication
(10) Pub. No.: US 2009/0291627 A1
(43) Pub. Date: Nov. 26, 2009

(54) Air Curtain Doorway With Integrated Doors

(76) Inventors: Charles A. Zimmermann, Pewaukee, WI (US); George F. Balbach, Lake Forest, IL (US)

Correspondence Address: QUARLES & BRADY LLP, 411 E. WISCONSIN AVENUE, SUITE 2040, MILWAUKEE, WI, 53202-4497, US

(21) Appl. No.: 12/469,062

(22) Filed: May 20, 2009

Related U.S. Application Data
(60) Provisional application No. 61/054,517, filed on May 20, 2008.

(51) Int. Cl. F24F 9/00; E06B 3/32; G05B 15/00

(52) U.S. Cl. 454/188; 160/266; 160/238; 160/309; 700/275

(57) ABSTRACT

An air curtain doorway defining an opening between at least two zones, including an air curtain having an air supply duct and an air return duct joined by a connecting duct. A frame having spaced apart jambs connected at the top by a header is configured to fit substantially within the opening of the air curtain. At least two roll-up doors in communication with the frame are configured to selectively insulate the at least first and second zones. A method of controlling a plurality of roll-up doors of an air curtain doorway comprises the steps of monitoring the output of at least a first sensor and a second sensor to sense approach of the doorway, applying logic to the output of the sensors, and controlling at least one of the doors based upon the result of the applied logic. The method can also include closing the roll-up doors while the air curtain is blowing, or turning off the air curtain and closing the roll-up doors.

### CROSS-REFERENCE TO RELATED APPLICATIONS

This application claims priority to U.S. Provisional Application No. 61/054,517 filed May 20, 2008.

### STATEMENT REGARDING FEDERALLY SPONSORED RESEARCH OR DEVELOPMENT

Not applicable.

### FIELD OF THE INVENTION

This invention relates to air curtains, and more particularly, to an air curtain doorway incorporating a plurality of doors for insulating the air curtain.

### BACKGROUND OF THE INVENTION

Many facilities have discrete areas wherein each area is maintained at a different climatic condition relative to an adjacent area. These segregated areas, or zones, occur at locations such as the interface between a loading dock and a storage facility. The loading dock may be located outdoors and therefore subject to the elements, while the storage facility may be in an environmentally controlled zone to ensure the integrity of the stored product and relative comfort of the personnel. Other facilities may have a large interior refrigeration zone where perishable food products are stored until shipment and an adjacent, warmer packaging area. These are just two examples of the many situations where there are adjoining areas, or zones, with differing climatic conditions and a desire to maintain efficient passage between the zones.

Roll-up doors and air curtains have been, and are currently, used to insulate between zones of differing climates while maintaining relative ease of passage between the zones. Both devices are briefly discussed below to provide the appropriate context for the present invention.

Roll-up doors are primarily used to close off sections of factories or warehouses, or to act as a door to outdoors. The doors are commonly composed of a flexible sheet, which may be a flexible web or polymer, fabric or polymer coated fabric, or interconnected horizontal slats connected to form a sheet. The sheet, whether flexible web or interconnected slats, is typically wound around a barrel roller at the sheet's upper end and weighted or biased downward at its lower end to keep the sheet taut. The roller is typically positioned across the top of the opening and secured to the header of the doorframe. The lateral sides of the sheet are generally guided by tracks located in the doorjambs forming the frame of the roll-up door. The door is deployed and retracted by rotating the barrel in the desired direction. Roll-up doors can be designed to be quickly deployed and retracted making them suitable for heavy-traffic environments, such as a loading dock.

Roll-up doors provide no insulation between zones when retracted and when down impede passage. Repeated operation also can take a mechanical toll on the components of the roll-up door, and although operation is quite rapid, it still does take some time. When the door is in the retracted position, it provides no insulation between the zones of differing climates, allowing for a free exchange of air between the two areas. Where the climate difference is greater, the exchange of air is more prevalent. This air exchange is costly; leaving air-conditioning equipment to compensate for the exchange, costing time and energy.

Air curtains are also used to separate sections of factories or warehouses, or to act as a door to outdoors. Air curtains produce a relatively high velocity air stream, generally from one side to the other or from top to bottom. One vertical end of the doorway of an air door has an air outlet and the other has an air inlet. An air mover, usually a fan, draws the air in the inlet, forces it through a duct typically located horizontally above the doorway, where it is then expelled through an outlet, only to be drawn in again by the air inlet and the process repeated. An air curtain can be constructed of a considerable size, in width and depth, to allow large machinery to easily pass through. Additionally, air is a good insulator and thus provides an efficient insulation between the zones of differing climatic conditions.

Air curtains draw in air from the adjacent zones and provide no insulation between zones unless the air curtain is on and blowing air. An air curtain exchanges air with the adjacent zones between which it is installed and in doing so can put an added load on the refrigeration system of the cold zone, or under some conditions can result in an undesirable formation of frost around the doorway if it draws in warm moist air from the warmer zone and cools it or blows it into the refrigerated zone. Also, running the air mover (e.g., electric fan) non-stop may not at times be the most efficient way to insulate between different zones during periods where passage between the zones is minimal, especially where the climatic differential is large between the adjacent zones.

### BRIEF SUMMARY OF THE INVENTION

The present invention addresses the current problems and inefficiencies by the novel integration and control of air curtains and roll-up doors. In particular, the present invention integrates the efficient insulation characteristics and ease of passage provided by an air door with the insulation properties of a roll-up door to arrive at a novel solution.

The present invention, in one embodiment, comprises an air door sandwiched between a pair of roll-up doors. The invention provides the efficiency and ease of passage of an air door during peak passage times and the ability to deploy the roll-up doors to minimize mixing of the zoned air during off-peak times and provide a more positive insulative barrier between the two zones, and also a barrier to passage. The integration of an air door and a pair of roll-up doors creates a redundant insulation system between zones. If the air door fails, both roll-up doors can be deployed to maintain an insulating layer of air sandwiched between the zones. Alternatively, if the roll-up doors fail, or are left in the retracted position, the air curtain maintains an thermally insulative barrier between the zones.

In particular, the present invention is an air curtain doorway for forming an insulative boundary. The doorway includes an air curtain located between at least two zones and having an air supply duct and an air return duct that are joined at the top by an air header duct. A frame is configured substantially within the air curtain envelope and includes spaced jambs connected at the top by a header. At least two doors are in communication with the frame and configured to selectively insulate the at least first and second zones.

The present invention also includes a method of controlling a plurality of doors of an air curtain doorway, including the steps of monitoring the output of at least a first sensor and a second sensor, applying logic to the output of the sensors, and controlling at least a first door and a second door based upon the result of the applied logic.

The foregoing and other objects and advantages of the invention will appear from the following description. In the description, reference is made to the accompanying drawings that form a part hereof and in which there is shown, by way of illustration, preferred embodiments of the invention. These embodiments, however, do not necessarily represent the full scope of the invention and reference must be made to the claims for determining the scope of the invention.

### BRIEF DESCRIPTION OF THE DRAWINGS

FIG. 1 is a front view of an air curtain doorway of the present invention;

FIG. 2 is a side view of the air curtain doorway of FIG. 1;

FIG. 3 is a top elevation view of the air curtain doorway of FIG. 1;

FIG. 4 is a partial elevation view of the air curtain doorway of FIG. 1;

FIG. 5 is a partial elevation view of an alternative air curtain doorway;

FIG. 6 is a partial elevation view of another alternative air curtain doorway.

### DETAILED DESCRIPTION OF THE PREFERRED EMBODIMENT

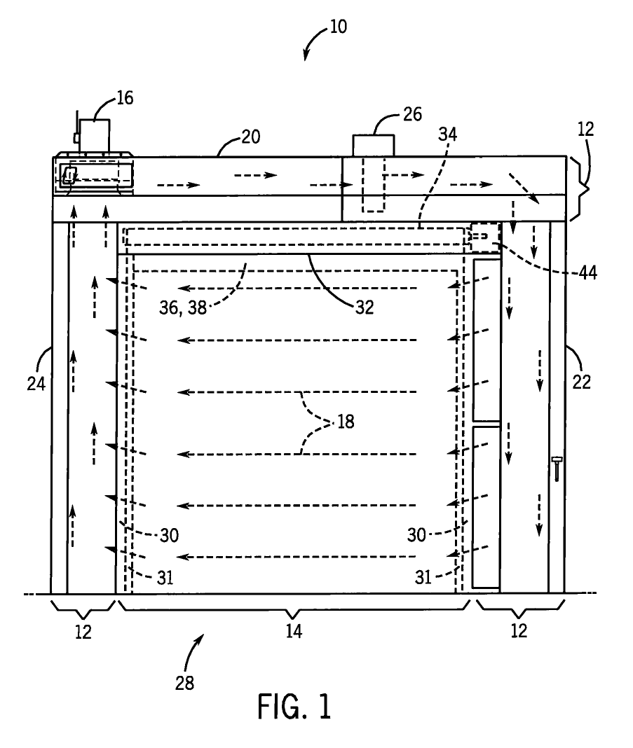

An air curtain doorway with integrated doors is generally designated by reference numeral 10 in FIG. 1. The doorway 10 includes two main portions, an outer air curtain assembly 12 and a door assembly 14. The structure and inter-operation of each portion is discussed in detail below.

### Air Curtain Assembly

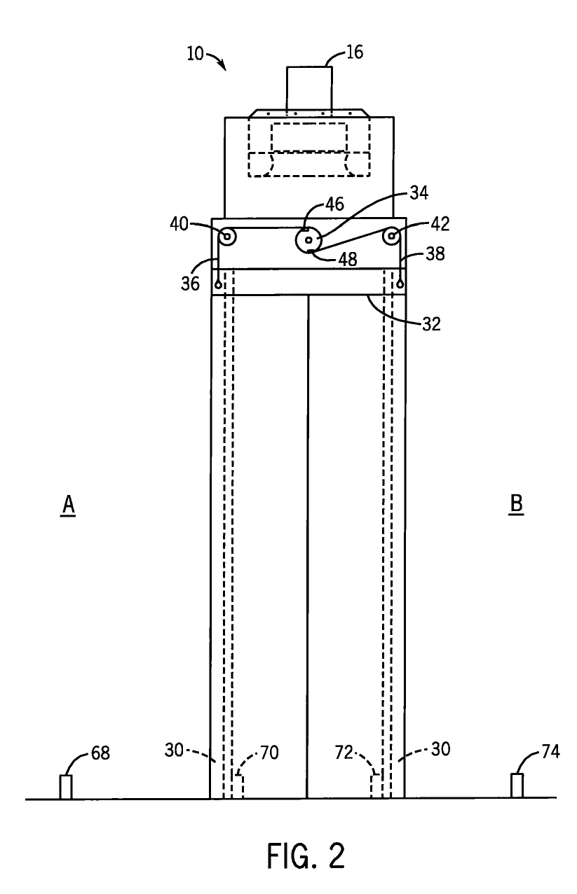

The air curtain assembly 12, shown in FIG. 1, uses a series of joined ducts 20, 22, 24 and an air mover 16 to create an air curtain 18. The air curtain 18 is generally used to separate areas, or zones, having differing climatic properties (e.g., temperature, humidity). As shown in FIG. 2, the doorway 10 is disposed between a first zone A and a second zone B. The air curtain 18 may be created to travel from right to left (as shown in the present embodiment for illustrative purposes), left to right, top to bottom, bottom to top, or any variation thereof. The disclosure of U.S. Pat. No. 6,595,429 of an air curtain and the control of an air curtain that may be used for the air curtain 18 is hereby incorporated by reference as if fully set forth herein.

In that air curtain, an air stream is formed across a doorway between areas of relatively cool and warm air masses including a supply air plenum with an outlet aperture at a first side of the doorway, a return air duct with an inlet aperture at a second side of the doorway and an intermediate air duct extending between the supply plenum and return air duct. An air mover moves the air stream across the doorway into the inlet aperture to the return air duct through the intermediate air duct to the supply air plenum and out of the outlet aperture. A heater in thermal communication with the air stream can warm the air stream when called for by an electronic control unit that controls the operation of the heater. A first air sensor is located in one of the relatively cool and warm air areas so as to provide an air characteristic input to the control unit. A second air sensor located in contact with the air stream also provides an air stream characteristic input to the control unit.

The control unit continuously monitors the air characteristic input and the air stream characteristic input and operates the heater to maintain the temperature of the air stream at a point substantially along a line representing the mixing of the air stream with one or both of the air masses that is tangent to the psychrometric saturation curve. The first air sensor may be located in the relatively warm air area. The first air sensor may include a first temperature sensor and a first humidity sensor and the second air sensor may include a second temperature sensor and a second humidity sensor. The first and second temperature sensors provide respective first and second temperature signals to the control unit and the first and second humidity signals provide respective first and second humidity signals to the control unit. The second air sensor may be located downstream from the air mover and may be located in the supply air plenum. The heater may be located in the intermediate air duct.

The control unit may be programmed with a parabolic approximation of the saturation curve, for example the parabolic approximation being generated by the equation y=0.139x²+0.2803x+4.1766, wherein y is in units of grains of water per pound of dry air and x is in units of temperature in degrees Fahrenheit. The mixing line may be defined by the equation y=[(Hₐₛ−Hₐ/(Tₐₛ−Tₐ)]x+Hₐₛ where Hₐₛ and Hₐ are the humidity of the air stream and anteroom air from the relatively warm air area, respectively, in grains of water per pound of dry air and Tₐₛ and Tₐ are the temperatures of the air stream and the anteroom air, respectively, in Fahrenheit. The apparatus may further include a first pressure sensor located in the relatively cool air area providing a cool air pressure input to the control unit and a second pressure sensor located in the relatively warm air area providing a warm air pressure input to the control unit and the control unit can continuously monitors the pressure input signals and operate the air mover to minimize cross-filtration through the doorway.

The apparatus may further include an air speed sensor detecting air velocity through the doorway and providing a cross-filtration air speed input to the control unit, so the control unit can continuously monitors the air speed input to minimize cross-filtration through the doorway. The apparatus can also include a dehumidifier to draw a dehumidified air flow into the air stream and can include a filtration system that removes contaminants from the air stream.

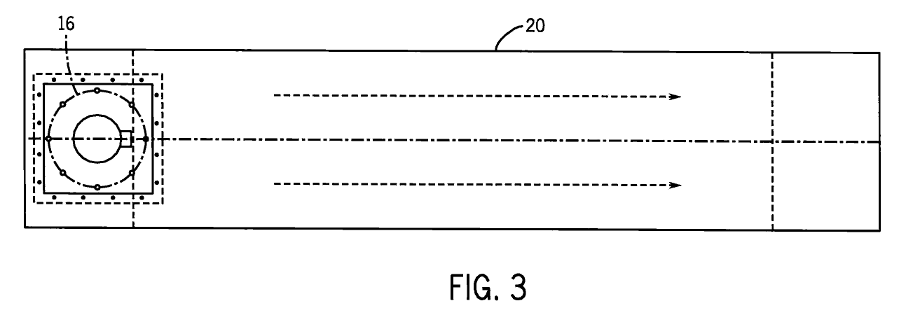

Referring to the drawings, the air curtain assembly 12 includes four main elements: (1) an air mover 16, (2) a header duct 20, (3) an air supply duct 22, and (4) an air return duct 24. The air supply duct 22 and air return duct 24 are spaced apart and joined at the top by a header duct 20. As viewed in FIG. 1, the upper portion of the air return duct 24 is in communication with the left portion of the header duct 20. The right portion of the header duct 20 is in communication with the upper portion of the air supply duct 22. The ducts 20, 22, 24 can be made from sheet metal or any other suitable material and are joined by suitable fasteners such as sheet metal screws, rivets, welding, fold joints, and the like. The air mover 16 (shown in FIGS. 1, 2, and 3) is typically mounted in the header duct 20 above the air return duct 24, but may be placed in another location if desired. The air mover 16 may be any type of fan (e.g., centrifugal plug fan, box fan, and the like) capable of creating a pressure differential resulting in airflow within the ducts as depicted by the dotted arrows in FIGS. 1 and 3. The specifications of the air mover 16 are specific to the application and determination of an appropriate air mover 16 is well known to those skilled in the art. The air curtain assembly 12 is sized to accommodate the doorway opening (not shown) for the particular application for which it is being used. The ducts are fitted securely within the doorway opening to provide a thermally insulating barrier to unwanted and uncontrolled airflow between zones A and B.

FIG. 1 illustrates the interaction of the four main elements of the air curtain assembly 12. The air mover 16 forces air across the header duct 20 towards the air supply duct 22. The header duct 20 may optionally include a heater 26, or any number of air conditioning devices, to condition the air as it travels in the header duct 20. Upon reaching the end of the header duct 20, the air is directed downwards into the air supply duct 22. The air is then directed out of the air supply duct 22 towards the adjacent air return duct 24, forming an air curtain 18. The air curtain 18 is then drawn into the air return duct 24 to repeat the cycle. The specifics of air doors are known to those skilled in the art, and it is only required here to have a general understanding of the operation thereof. We turn next to the integration of the door assembly 14 with the air curtain assembly 12.

### Door Assembly

The door assembly 14 includes several elements that combine to define an opening 28 between zone A and zone B. Referring to FIGS. 1 and 2, spaced apart jambs 30 are connected at their top by a header 32. The jambs 30 and header 32 are sized to fit within the inner envelope defined by the air return duct 24, the header duct 20, and the air supply duct 22. As seen in FIG. 2, the jambs 30 are found on both the zone A side and the zone B side but do not impede the flow of the air curtain 18. The jambs 30 may contain tracks 31 configured to engage the lateral edges of the doors 36, 38 and may guide the doors 36, 38 from a retracted to deployed position and the reverse. The jambs 30 and tracks 31 may be constructed from any material suitable for the environment and capable of repeated use, for example, metals and plastics are preferred materials.

The doors 36, 38 are commonly composed of a flexible fabric sheet or interconnected horizontal slats connected to form a sheet (not shown). The upper end of the sheet, whether fabric or interconnected slats, is typically connected to a barrel roller (described below) and the lower end of the sheet is weighted or biased downwards at its lower end to keep the sheet taut. The lateral sides of the sheet are generally, but need not be, guided by tracks 31 located in the jambs 30 forming the frame of the roll-up door. Additionally, the bottom corners of the doors 36, 38 may be captured within the tracks 31 and may further include a wheel or friction member to facilitate relative movement between the tracks 31 and the bottom corners. The specifics of guiding a door by tracks are well known by those skilled in the art.

### Door Assembly Configurations

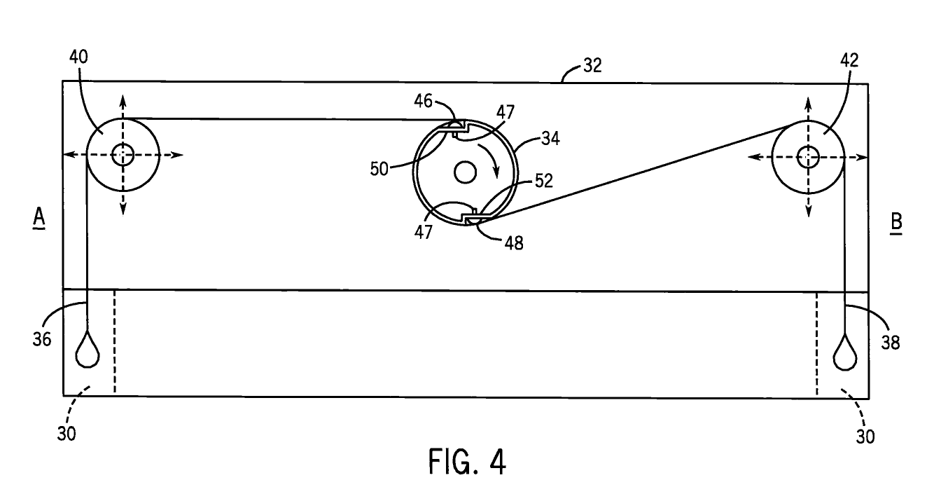

Referring to FIGS. 1, 2 and 4, one preferred embodiment of the door assembly 14 comprises (1) a double barrel roller 34, (2) a first door 36, (3) a second door 38, (4) a first idler 40, (5) a second idler 42, and (6) a drive 44. The drive 44 may be located in the header 32 and may be combined with a gearbox (not shown) depending upon the application requirements and drive 44 selection. One of ordinary skill in the art will appreciate the vast options available depending upon packaging limitations, torque requirements, door size, and similar considerations. Looking closely at FIG. 2, a first door 36 disposed adjacent to zone A and a second door 38 disposed adjacent to zone B are depicted with the air curtain 18 (shown in FIG. 1) sandwiched between the doors 36, 38. An enlarged view of the header 32 is shown in FIG. 4.

In this embodiment, both doors 36, 38 are connected at their respective upper edges to a single double barrel roller 34 and therefore capable of being driven by a single drive 44. The double barrel roller 34 is a generally cylindrically shaped rod or tube having a length substantially equal to the width of the header 32. There are numerous ways to attach the doors 36, 38 to the double roller 34 (e.g., gluing, riveting, molding, inserting into a longitudinal slot in the roller 34, and the like), however, the preferred method will be described in detail. The upper edge of the first door 36 is attached to the double roller 34 at a first location 46 by at least two fasteners 47, one fastener 47 near each lateral edge of the door 36, 38, acting to clamp the upper edge of the first door 36 between the head of the fastener 47 and the first cutout 50 of the double roller 34. The second door 38 is attached in the same manner to the double roller 34 at a second cutout 52 located approximately 180 degrees from the location of the first cutout 50. The first cutout 50 and second cutout 52 define L-shaped lands that extend the length of the double roller 34. While the attachment location of each door is different, as just described, the routing of the doors 36, 38 to the adjacent zones A and B is similar.

The doors 36, 38 extend outwardly from the double roller 34. The first door 36 extends outwardly towards zone A and is routed over a first idler 40 rotatably mounted substantially above the jamb 30 near zone A. The first door 36 passes over the first idler 40 and continues downward where the lateral edges of the first door 36 may be guided by tracks 31 (shown in FIG. 1) in the jambs 30. The second door 38 is routed similarly to the first door 36, albeit towards zone B. The second door 38 extends outwardly towards zone B and is routed over a second idler 42 rotatably mounted substantially above the jamb 30 near zone B. The second door 38 passes over the second idler 42 and continues downward where the lateral edges of the second door 38 may be guided by tracks 31 (shown in FIG. 1) in the jambs 30. The first door 36 is adjacent to zone A and the air curtain 18, and the second door 38 is adjacent to zone B and the air curtain 18. Thus, when deployed, the doors 36, 38 insulate the air curtain 18 from zones A and B.

The idlers 40, 42 are generally cylindrically shaped rods or tubes having a length substantially equal to the width of the header 32. Idlers 40, 42 may be adjustable to accommodate variations and wear in the door assembly 14, and the height that the door must close. FIG. 4 shows that the idlers 40, 42 may be adjusted left, right, up, and down, or any combination thereof, (as viewed in FIG. 4) to account for variations in the door assembly 14, for example, idler wear, door length variation and wear, and any other system variation. The adjustments may be made in several ways, including slotted idler 40, 42 mounting holes, multiple mounting holes, the use of oversized mounting holes and larger pressure washers used to clamp the idlers 40, 42 in place, and various other techniques known in the art. One skilled in the art would also appreciate that the double roller 34 can be made adjustable using the same techniques. The idlers 40, 42 and double roller 34, can be manufactured from various metals, plastics, composites, or any suitable material capable of meeting the demands of the particular application. Considerations include the operating temperature, frequency of use, and chemical exposure, to name a few.

Multiple idlers 40, 42 may be used depending upon the situation. The placement of the double roller 34 may require multiple idlers to accommodate a more involved door path. Other components in the header 32 may require specific routing of the doors 36, 38 for proper alignment and prevent the unobstructed path depicted in FIG. 4. Additionally, a series of idlers may be incorporated to act as a pulley system to reduce the torque load on the drive 44.

As a general note, the barrels and idlers discussed above and below are all rotatably secured, preferably at the ends, to the header 32 by a bearing. Many configurations and styles of bearings may be used. For example, the barrel or idler may include a stepped down core with splines configured to engage a similarly splined inner ring of a ring bearing. The exterior housing of the ring bearing may then be secured to the header 32. In addition, the barrels and idlers may be mounted directly to the jambs 30 or to the air curtain assembly 12 using the same techniques discussed. One of ordinary skill in the art will recognize numerous rotational attachments available without departing from the scope of the present invention.

The above preferred embodiment operates as follows. Both doors 36, 38 are deployed when the double roller 34 is rotated counter-clockwise (as viewed in FIG. 4). In that direction, the first door 36 and second door 38 unwind from the double roller 34 and progress towards the base of the jambs 30. The unwinding of the double roller 34 may be controlled in a variety of manners, including sensors (not shown) located at the base of the jams 30 in communication with the drive 44 that send a signal to de-energize the drive 44 when a first door 36 or second door 38 achieve a predetermined location. Alternatively, a counting sensor (not shown), such as a magnetic pickup, may be incorporated into the double roller 34 or drive 44 and send a signal to de-energize the drive after a predetermined number of double roller 34 or drive 44 rotations have been counted.

The doors 36, 38 are retracted when the double roller 34 is rotated clockwise (as viewed in FIG. 4). The first door 36 and second door 38 wind around the double roller 34 and progress towards the top of the jams 30. The winding of the double roller 34 may be controlled in a similar manner with sensors (not shown) placed near the top of the jambs 30 sending a signal to de-energize the drive when a first door 36 or a second door 38 reaches a predetermined position. Similarly, the number of double roller 34 or drive 44 rotations can be counted and used for drive control. In addition, an operator may control deployment or retraction either manually or with the aid of an electronic control station (e.g., a switch having three positions, up, stop, and down). Methods of control are discussed in more detail below.

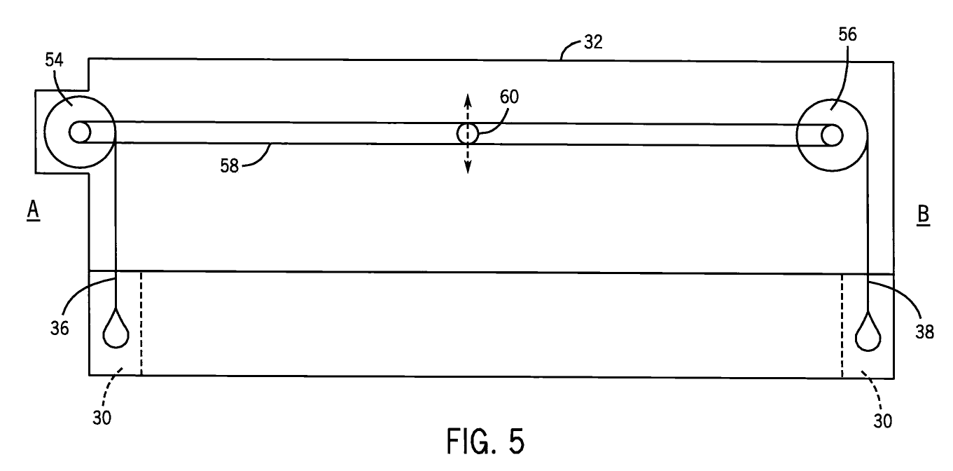

A second embodiment of the door assembly 14 is depicted in FIG. 5. Unlike the first embodiment (shown in FIG. 4), the first door 36 and second door 38 are not connected to the same roller. The first door 36 is connected to a master roller drive 54. The master roller drive 54 is a combination roller and drive that is connected to a slave roller 56 via a belt or chain 58. An intermediate adjustable support idler 60 may be included along the path of the belt or chain 58 to both provide support thereto and adjust the tension in the belt or chain 58. The belt or chain 58 may be connected to a stepped down portion of the master roller drive 54 and slave roller 56. As in the first embodiment, the master roller drive 54 and slave roller 56 may be adjusted left, right, up, and down to account for imperfections and system wear.

Similar to the first embodiment, both doors 36, 38 are typically driven simultaneously and in the same direction, either deployed or retracted. As depicted in FIG. 5, the doors 36, 38 are retracted when the master roller drive 54 is rotated counter-clockwise and the doors 36, 38 are deployed when the master roller drive 54 is rotated clockwise. Similar roller and door 36, 38 control systems can be used to direct the retraction and deployment of the doors 36, 38.

The use of a reversing gear, for example, on the slave roller 56 would cause the second door 38 to deploy as the first door 36 is retracted and the reverse. Additionally, the master roller drive 54 may be configured to mirror the rotation of the slave roller 56, similar to FIG. 4 without the double roller 34. In this case, the use of a reversing gear would synchronize the retraction and deployment of the doors 36, 38.

In another example, two electric clutches may be used to obtain independent deployment and retraction of the doors 36, 38. A first electric clutch (not shown) located at the interface between the master roller drive 54 and belt or chain 58 is used to engage and disengage the belt or chain 58, thus controlling the driving force applied to the slave roller 56. A second electric clutch (not shown) located at the interface between the door assembly 14 and the slave roller 56 is used to lock and unlock the rotation of the slave roller 56 to prevent the second door 38 from deploying or retracting when not desired. When the first clutch is disengaged, the master roller drive 54 only controls the deployment and retraction of the first door 36. When the first clutch is engaged and the second clutch is disengaged, allowing the slave roller 56 to rotate, the slave roller 56 and master roller drive 54 are in driving engagement. In this situation, the master roller drive 54 can only be used to retract the slave roller 56 when both are in the deployed position. Similarly, the master roller drive 54 can only be used to deploy the slave roller 56 when both are in the retracted position. The slave roller 56 may be locked by the second electric clutch in the deployed or retracted positions and the master roller drive 54 operated independently. Other electric clutch combinations exist and would be appreciated by one skilled in the art as falling within the scope of the present invention.

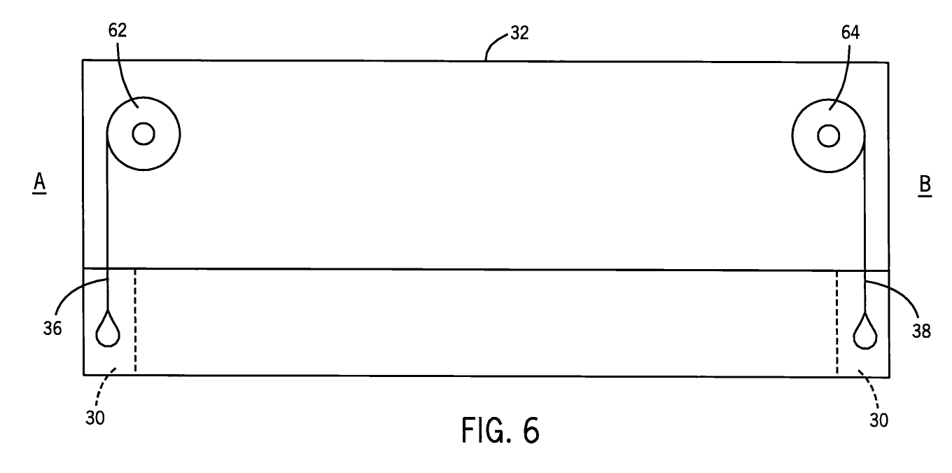

A third embodiment of the door assembly 14 is depicted in FIG. 6. Unlike the previous two embodiments, the third embodiment includes two independently driven barrel rollers 62, 64. The first door 36 is connected to a first roller drive 62 rotatably mounted to the header 32 above the jamb 30 adjacent to zone A. The second door 38 is connected to a second roller drive 64 rotatably mounted to the header 32 above the jamb 30 adjacent to zone B. Both the first roller drive 62 and the second roller drive 64 are independently capable of driving the first door 36 and second door 38, respectively. Additionally, the first roller drive 62 and second roller drive 64 can be controlled together or independently of the other. As with the second embodiment, similar roller and door 36, 38 control systems can be used to direct the retraction and deployment of the doors 36, 38. The drive rollers 62, 64 may alternatively be mounted directly to the header duct 20, the jambs 30, or the air return duct 24, or air supply duct 22, or any combination thereof.

### Door Control

The present invention includes novel means of door control when integrated with an air curtain. Four general modes of door control will be discussed, including (1) general door control, (2) traffic flow logic, (3) time based logic, and (4) fault state logic. Each method of control is described below.

General control involves determining when to deploy and retract one or both doors. Input from sensors may be supplied to a programmable logic controller (“PLC”) (not shown). The PLC may then use the sensor input to determine whether to deploy and retract the doors 36, 38 depending upon preconfigured logic. For example, clutches and the drive 44 may be controlled by the PLC, that is, based upon the state of the sensors, the drive 44 can be energized, a clutch engaged, and a door opened.

Ideally, four or more sensors would be incorporated to determine the presence of objects (e.g., machinery, workers, merchandise, and the like) approaching, within, and exiting the doorway 10. Thus, turning to FIG. 2, a first sensor 68 is located in zone A and is adjacent to the first door 36. A second sensor 70 is located within the air curtain 18 proximate to the first door 36. A third sensor 72 is located within the air curtain 18 proximate to the second door 38. Finally, a fourth sensor 74 is located in zone B and is adjacent to the second door 38. Greater or fewer sensors may be used depending upon the sensor accuracy and desired coverage. The preferred embodiment includes sufficient sensors to determine when an object is approaching either door 36, 38 from zone A or zone B, or from within the air curtain 18.

A non-exhaustive example of the door control will be described. As an object approaches the doorway 10 from within zone A, the first sensor 68 detects its presence and sends a signal to the PLC. The PLC energizes or de-energizes the driver 44, drivers, and clutches, depending upon the embodiment in use, and causes the first door 36 (or both doors 36, 38) to retract assuming they were in the deployed position. As the object enters the doorway 10, the second sensor 70 sends a signal to the PLC indicating the object's presence. At this point, the PLC can logically decide if the first door 36 should be re-deployed or if it needs to remain retracted, for example, if the first sensor 68 indicates the continued presence of an object, the first door 36 will remain retracted. As the object proceeds within the doorway 10 toward zone B, the third sensor 72 will detect the object and send a signal to the PLC. The PLC can then energize the driver 44 or, again depending upon the configuration, drivers or clutches, to retract the second door 38, allowing the object to exit the doorway 10. Finally, the fourth sensor 74 will detect the object as it exits into zone B and send a signal to the PLC, at which time the PLC will determine if the doors 36, 38 should be retracted or deployed. The PLC can be configured to monitor traffic entering the doorway 10 from both zone A and zone B simultaneously.

Traffic flow logic may be used to control the deployed or retracted state of the doors 36, 38. For example, the PLC can calculate the average number of objects traveling through the doorway 10 over a certain period. If that average number of objects per time is calculated to be below a predetermined threshold, the PLC may revert to a deployed state wherein the doors 36, 38 are maintained in a deployed position until the sensors 68, 70, 72, 74 detect an object. If the traffic flow increases above the predetermined threshold, the PLC will revert to a retracted state wherein the doors 36, 38 are maintained in a retracted position allowing easy passage through the doorway 10. This logic minimizes the wear and tear on the door assembly 14 and prohibits mixing zone A and zone B air into the air curtain 18 during periods of reduced traffic flow.

Time based logic may be employed to control the doors 36, 38. For example, the PLC may be programmed to maintain the doors in the retracted position during predetermined business hours and in a deployed position outside of business hours. This further reduces the wear and tear on the door assembly 14 and increases the efficiency of the air curtain assembly 12 outside of business hours. Additionally, the PLC may be configured to de-energize the air mover 16 during specified periods, for example if both doors are to be closed for a substantial period, to further save energy and reduce wear upon the air mover 16.

Fault conditions may be used to alter the PLC control. For example, a pressure tube may be used to monitor the air curtain 18. If the flow of air falls below a certain level due to a fault (e.g., a degraded air mover 16, a blocked air return duct 24 or air inlet duct 22, and the like), the PLC may be programmed to de-energize the air mover 16 and enter a deployed state wherein the doors 36, 38 are maintained in a deployed position until the sensors 68, 70, 72, 74 detect an object. Additionally, a fault condition may occur if an object has entered the doorway 10 and has remained therein for longer than a predetermined period. For example, if an object enters the doorway 10 via zone A, the second sensor 70 will detect its entering the air curtain assembly 12. If the object is not sensed, in a timely manner, by either the third sensor 72 and fourth sensor 74 (i.e., proceeds to exit the doorway 10 into zone B) or by the second sensor 70 and first sensor 68 (i.e., exits back into zone A) a fault will be triggered and both doors 36, 38 will be retracted until the fault condition is remedied.

A preferred embodiment of the present invention has been described in considerable detail. Many modifications and variations of the preferred embodiment described will be apparent to a person of ordinary skill in the art. Therefore, the invention should not be limited to the embodiments described.

We claim:

1. An air curtain doorway comprising:
an air curtain comprising an air supply duct and an air return duct joined by a connecting duct and defining an opening between first and second zones across which the air curtain supplies a stream of air in an air space that extends from the supply duct to the return duct;
a first roll-up door adjacent to the first zone and a second roll-up door adjacent to the second zone, said roll-up doors being wound on at least one roller, said doors being deployable to have at least a substantial portion of the air space between them and retractable so as to allow passage through the air space between the first and second zones.

2. The air curtain doorway of claim 1, wherein the doors have edges guided by tracks at the sides of the air space.

3. The air curtain doorway of claim 1, wherein both doors are wound on a single roller.

4. The air curtain doorway of claim 3, wherein the first door is connected to a first location of the roller and the second door is connected to a second location of the roller approximately 180 degrees from the first location.

5. The air curtain doorway of claim 4, further comprising:
a drive for turning the roller so as to deploy and retract the first and second doors.

6. The air curtain doorway of claim 1, further comprising:
a first idler roller over which the first door is draped so as to guide the first door to one side of the air space; and
a second idler roller over which the second door is draped so as to guide the second door to the other side of the air space.

7. The air curtain doorway of claim 6, wherein at least one of the first and second idler rollers is adjustable in position.

8. The air curtain doorway of claim 1, further comprising:
a slave roller connected to the second door;
a master roller drive connected to the first door and in driving engagement with the slave roller such that the master roller drive drives the deployment and retraction of the first and second doors.

9. The air curtain doorway of claim 1, further comprising:
a first roller drive connected to the first door for driving deployment and retraction of the first door; and
a second roller drive connected to the second door for driving deployment and retraction of the second door.

10. The air curtain doorway of claim 1, wherein the lateral edges of at least one of the at least first and second doors is at least partially constrained by tracks at the sides of the air space.

11. An air curtain doorway comprising:
an air curtain that blows a stream of air across a doorway that is between two zones separated by the doorway;
a pair of roll-up doors, one adjacent to one of the zones and the other adjacent to the other zone, that can be deployed to border the stream of air with the stream of air between the doors.

12. A method of controlling a plurality of roll-up doors, one on each side of an air curtain doorway, comprising the steps of:
monitoring the output of at least a first sensor and a second sensor to determine approach of the doorway;
applying logic to the output of the at least first sensor and second sensor; and
controlling at least the first roll-up door and the second roll-up door based upon the result of the applied logic.

13. A method as in claim 12, further comprising deploying the two roll-up doors while the air curtain is blowing an air stream across the doorway to substantially envelop the air stream between the doors.

14. A method as in claim 12, further comprising deploying the two roll-up doors and shutting down any air stream blown by the air curtain.

15. A method as in claim 12, wherein the temperature of the air stream is controlled to a point substantially along a line representing the mixing of the air stream with one or both of air masses in the first and second zones that is tangent to the psychrometric saturation curve.

16. A method as in claim 15, wherein the air curtain includes a heater, an electronic control unit and temperature and humidity sensors, wherein the control unit controls operation of the heater according to temperature and humidity input received from the temperature and humidity sensors.

17. A method as in claim 16, further comprising monitoring the pressure of relatively cool air in one of the zones and relatively warm air in the other of the zones and adjusting the air stream flow rate so to minimize cross-filtration through the door way.

18. A method as in claim 16, wherein the air curtain further includes an air mover generating the air stream and wherein the control system further includes pressure sensors, wherein the control unit operates the air mover according to input from the pressure sensors.

19. A method as in claim 15, further comprising monitoring the flow rate of air flowing away from the air stream and adjusting the air stream flow rate so as to minimize cross-filtration through the door way.

20. A method as in claim 15, further comprising at least one of the steps of: mixing air from the cool air zone into the air stream; mixing de-humidified air into the air stream; and filtering the air stream to remove contaminants therein.
